(19) United States
(12) Patent Application Publication
(10) Pub. No.: US 2014/0172451 A1
(43) Pub. Date: Jun. 19, 2014

(54) SYSTEMS AND METHODS FOR MEDICAL INFORMATION MANAGEMENT

(71) Applicants: Peter Hudson, Evergreen, CO (US); Wayne Guerra, Bow Mar, CO (US)

(72) Inventors: Peter Hudson, Evergreen, CO (US); Wayne Guerra, Bow Mar, CO (US)

(73) Assignee: HEALTHAGEN LLC, Lakewood, CO (US)

(21) Appl. No.: 13/108,867

(22) Filed: May 16, 2011

(51) Int. Cl. G06Q 50/00

(52) U.S. Cl. 705/3

(57) ABSTRACT

Systems and method for communication of information to one or more medical care providers. The systems and methods may utilize a client with which a user may interact. As such, the user may utilize the client to research, display, and/or select a medical care provider. The user may input information to the client which is transmitted to a selected medical care provider prior to the user arriving at the medical care provider's facility. This may include an indication of the user's intent to visit the medical care provider. As such, the medical care provider may utilize the data received to generate a chart and make preparations (e.g., reserve resources) in anticipation of the user's visit. The user may also use the client to access and/or share a personal health record.

### FIELD

The present invention generally relates to the management of medical information and more specifically to the communication of information to a medical care provider prior to the administration of medical care to a patient.

### BACKGROUND

Upon arrival of a patient seeking to obtain medical care at a medical provider's facility (e.g., in an emergency, primary care, or specialty context), the patient may be required to provide the medical care provider with information that may include, for example, identifying information, insurance information, medical history information, or other appropriate information to facilitate the medical care. This information is usually provided in the form of written notes on a form or other sheet that is entered into a physical file or chart for the patient. This information may be transcribed into digital form by administrative personnel.

Once information is collected by the administrative staff of the medical care provider, the patient is often evaluated by a nurse or other medical personnel to collect pertinent information regarding the nature of the visit or the care sought prior to receiving the medical care. This may involves obtaining information from the patient such as the patient's temperature, blood pressure, pulse, or other medical information. The nature of the information obtained from the patient may be related to the symptom(s), condition(s), or medical procedure(s) for which the patient is seeking medical care. Additionally, questions regarding the nature of the visit may be asked of the patient prior to the administration of medical care, and the answers to such questions may be entered into the patient's chart for further evaluation by a doctor or the like. These questions may include questions related to the reason for the patient's visit including, for example, the full extent of the symptoms, the amount of time that the symptoms have been present, or other information specific to the nature of the visit.

### SUMMARY

It has been recognized that the collection of information in the manner described above is time consuming, relies on the patient having access to or knowledge of certain information at the medical care provider facility (e.g., insurance policy numbers, past medical history information or the like), and may delay the administration of medical care. Moreover, the patient's personal medical history may not be accessible in a single chart or file, but may be divided among a number of medical care providers. Accordingly, each provider may have access to a portion of, but not the entirety of, the patient's personal medical history

Furthermore, the steps of manual data collection upon arrival of the patient to a medical care facility add extra time and complexity to the process of seeking medical care and may require the time of the medical care facility staff to collect and organize data at the time of the visit or after the visit. This may lead to increased cost and introduce the potential for mistakes (e.g., due to sloppy handwriting, misplaced notes, etc.). Further still, in the emergency medical context in particular, the above method of data collection and organization may delay the administration of medical care. Also, information not known by the medical care provider about a patient may lead to mistakes, misdiagnosis, or misinformed conclusions on the part of the medical care providers.

It has been further recognized that the overhead, cost, and possible disadvantages associated with the above described data collection and management may be advantageously minimized so as to improve the quality and efficiency of medical care providers. The present invention employs the use of information technology in the medical field to facilitate increased efficiency when providing medical care. In this regard, the present invention may facilitate efficient exchange of data between medical care providers and patients. The present invention may allow users and/or patients to conveniently provide medical information without the need for medical care provider staff to collect such data directly from the user/patient. In this regard, the cost associated with administrative tasks ancillary to the provision of medical care may be reduced and the quality of medical care administered may be improved. This efficient data exchange may also limit the potential error introduced by the relay of medical information in the manner discussed above. Further still, the personal health record reflecting the overall health condition of the patient may be easily shared among one or more medical care providers.

A first aspect of the present invention includes a method for use in communicating information pertaining to medical care. The method includes receiving a selection of a selected medical care provider from a medical care provider listing. The medical care provider listing includes information related to a plurality of medical care providers. The selection of a selected medical care provider indicates the user intends to visit the selected medical care provider. The method also includes obtaining user data regarding the user. Additionally, the method includes receiving contextual information received from one or more data prompts. The one or more data prompts include at least one contextual question. The contextual question is at least partially based on an indication of at least one of a symptom, a disease, or a medical procedure provided by the user. The method further includes transmitting the user data and the contextual information to the selected medical care provider prior to the user visiting the medical care provider. At least a portion of the user data and the contextual information comprises at least a portion of a templated chart at the selected medical care provider.

A number of feature refinements and additional features are applicable to the first aspect of the present invention. These feature refinements and additional features may be used individually or in any combination. As such, each of the following features that will be discussed may be, but are not required to be, used with any other feature or combination of features of the first aspect. The following discussion is applicable to the first aspect, up to the start of the discussion of a second aspect of the present invention.

In one embodiment, the method of the first aspect further includes searching the medical care provider listing based on a location of the user. For example, the location of the user may be determined using a location module of a mobile device. Additionally, the method of the first aspect may include filtering the medical facility listing based on medical network information. For example, medical network information may include, but is not limited to, an insurance carrier of the user, an HMO to which the user belongs, or other appropriate medical network information.

In another embodiment, the user data may at least partially comprise a personal health record. The personal health record may be accessible by access to a server. Additionally, access to the personal health record may be secure and may require a name and password combination prior to being granted access to the personal health record.

In another embodiment, the templated chart may be employed by the medical facility to reserve resources at the medical facility. Such resources may include personnel resources, equipment, facilities, or other appropriate resources.

In yet another embodiment, the method of the first aspect may include providing available appointment times for the selected medical care provider, receiving a selection of a selected appointment time and sending an appointment request corresponding to the selected appointment time to the selected medical care provider. This may be facilitated by automated communication, direct interface with a practice management system of the selected medical care provider, or any other appropriate means.

In another embodiment, the at least one of a symptom, a disease, or a medical procedure provided by the user may be provided during the obtaining operation. In this regard, the at least one of a symptom, a disease, or a medical procedure provided by the user may correspond to an indicated reason for the visit to the selected medical care provider.

A second aspect of the present invention includes a method for use in communicating information pertaining to medical care using a mobile device. The method includes presenting to a user, on a mobile device, one or more data prompts. Additionally, the method includes collecting data from the one or more data prompts. The data comprises at least one of identification information, medical information, or medical network information related to a patient. Additionally, the method involves transmitting the data from the mobile device for delivery to a medical care provider. The transmitting occurs prior to administration of the medical care to the patient.

A number of feature refinements and additional features are applicable to the second aspect of the present invention. These feature refinements and additional features may be used individually or in any combination. As such, each of the following features that will be discussed may be, but are not required to be, used with any other feature or combination of features of the second aspect. The following discussion is applicable to the second aspect, up to the start of the discussion of a third aspect of the present invention.

In one embodiment, the user may be the patient. That is, the user may utilize the method according to the second aspect with respect to medical care for himself or herself. Alternatively, a user may use the method with respect to medical care for another. For example, the user may be an emergency medical technician (EMT) or the like responding to an emergency situation.

In another embodiment, the method may also include searching a medical care provider listing using the mobile device, presenting medical care provider information corresponding to results of the searching to the user on the mobile device, and receiving an indication of a selected medical care provider selected from the medical care provider listing. The searching may be at least partially based on selection of a symptom, a condition, a disease, a medical procedure, a medical specialty, a wait time, location information, or the medical network information.

In yet another embodiment, the method may include displaying, on the mobile device, one or more available appointment times for the selected medical provider. In turn, the method may involve obtaining a selected appointment time selected from the available appointment times. Additionally, the method may include communicating the selected appointment time for delivery to the selected medical provider.

In another embodiment, the mobile device data may be generated using the mobile device and may not be collected using the one or more data prompts. The mobile device data may include at least one of the location information, audio, one or more pictures, or one or more videos. As such, the mobile device data may be obtained via a location module and/or camera module of the mobile device.

In yet another embodiment, at least a portion of a chart for the patient at the medical care provider may be generated based on at least one of the data or the mobile device data. Additionally, the one or more data prompts may be based at least partially on the selected medical provider. Additionally or alternatively, the one or more data prompts may include one or more contextual questions. The one or more contextual questions may be at least partially based on at least one of a symptom, a disease, a medical procedure, or other appropriate information. User responses to the one or more contextual questions may be compiled with the chart for the patient. At least one of the identification information or the medical information may be obtained by way of accessing a personal health record corresponding to the patient.

A third aspect of the present invention includes a system for communicating medical information. The system includes a client operative to filter a medical provider listing, which includes entries related to a plurality of medical care providers, based on at least one of location information, symptom information, disease information, medical procedure information, appointment availability, a wait time, or medical network information. The client is disposed remotely from the plurality medical providers, which are operative to receive medical information from the client. The system also includes a data entry prompt displayable by the client to collect the medical information. The data entry prompt is at least partially based on at least one of the symptom information, the disease information, or the medical procedure information collected from the user. The client is operable to transmit the medical information to a server in operative communication with the client. The server is in further operative communication with at least one medical care provider such that the medical care provider receives said medical information prior to the user arriving at the medical care provider.

A number of feature refinements and additional features are applicable to the third aspect. These additional features and feature refinements may be used individually or in any combination. As such, each of the following features that will be discussed may be, but are not required to be, used with any other feature or combination of features of the third aspect. The following discussion is applicable to the third aspect, up to the discussion of a fourth aspect of the present invention.

In one embodiment, the client is operative to receive a selection of a selected medical care provider selected from the medical care provider listing. Receipt of the selection may indicate an intent by the user to visit the selected medical care provider. In another embodiment, the data entry prompt comprises at least one contextual question. The at least one contextual question may be at least partially based on at least one of the symptom information, the disease information, or the medical procedure information provided by the user. The medical information may comprise at least a portion of a templated user chart for use at the medical care provider.

In another embodiment, the location information is determined using a location module of a mobile device on which the client is executed. In another embodiment, the medical information at least partially comprises a personal healthcare record accessible by the client. Accordingly, the client may be operative to communicate with a server to access a personal healthcare record. The personal healthcare record may be secure such that a username and password combination is required to access the personal healthcare record.

Another embodiment includes an appointment scheduling prompt displayable by the client. The appointment scheduling prompt may be operative to display available appointment times for the selected medical care provider. Furthermore, the appointment scheduling prompt may be operative to receive from a user a choice of a selected appointment time from the available appointment times.

A fourth aspect of the present invention includes a system for communicating medical information. The system includes a client communication module in operative communication with a client. The client communication module is operable to receive medical information from the client. The medical information received from the client comprises an indication of a user's intent to visit at least one of a plurality of medical care providers. The system also includes a medical care provider communication module in operative communication with the plurality of medical care providers. The medical care provider communication module is operable to transmit the medical information to the at least one of said plurality of medical care providers prior to the user visiting said at least one of the plurality of medical care providers.

A number of feature refinements and additional features are applicable to the fourth aspect. These feature refinements and additional features may be used individually or in any combination. As such, each of the following features that will be discussed may be, but are not required to be, used with any other feature or combination of features of the third aspect.

In one embodiment, the medical information at least partially comprises contextual information received from one or more data prompts, said one or more data prompts including at least one contextual question, wherein said contextual question is at least partially based on an indication of at least one of a symptom, a disease, or a medical procedure provided by a user of said client. The medical information may comprise at least a portion of a templated chart for use at the medical care provider. In another embodiment, the medical care information at least partially comprises a personal healthcare record.

The system may also include a scheduling module that is operative to send to the client one or more available appointment times corresponding to one or more of the plurality of medical care providers. The scheduling module is also operative to receive a selection of a selected appointment time from among the available appointment times. The scheduling module may further be operative to retrieve from the one or more of said plurality of medical care providers the one or more available appointment times and to send the selected appointment time to a corresponding one of said plurality of medical care providers.

### BRIEF DESCRIPTION OF THE FIGURES

FIG. 1 is a schematic view of an embodiment of a system for communication of information between a client and one or more medical care providers.

FIG. 2 is a flow chart of an embodiment of a method for communication of information between a client and one or more medical care providers.

FIG. 3 is a flow chart of an embodiment of another method for communication of information between a client and one or more medical care providers.

FIG. 4 is a screen shot of a home screen of an embodiment of a client.

FIGS. 5 and 6 are screen shots of a medical care provider search screen of the embodiment depicted in FIG. 4.

FIGS. 7 and 8 are screen shots of a medical care provider listing of the embodiment depicted in FIG. 4.

FIGS. 9 and 10 are screen shots of an information input screen of the embodiment depicted in FIG. 4 that include a plurality of data prompts.

FIGS. 11 and 12 are screen shots of the information input screen of FIGS. 9 and 10 that includes user responses to the data prompts.

FIG. 13 is a shot of a personal health record login screen of the embodiment depicted in FIG. 4.

FIG. 14 is a screen shot of a personal health record screen of the embodiment depicted in FIG. 4.

FIG. 15 is a schematic view of another embodiment of a system for communication of information between a client and one or more medical care providers.

### DETAILED DESCRIPTION

Reference will now be made to the accompanying drawings, which at least will assist in illustrating the various pertinent features of the present invention. In this regard, the following description is presented for purposes of illustration and description and is not intended to limit the invention to the form disclosed herein. Consequently, variations and modifications commensurate with the following teachings, and skill and knowledge of the relevant art, are within the scope of the present invention. The embodiments described herein are further intended to enable others skilled in the art to utilize the invention as described or in other embodiments and with various modifications required by the particular applications or uses of the present invention.

The present invention facilitates communication of information to a medical care provider prior to the administration of medical care to a user. For instance, information may be entered by a user at a client remote from a medical care provider facility that ultimately receives the information. In this regard, systems and methods according to the present invention may be used to reduce the overhead associated with administrative tasks pertaining to, for example, client check in, routine medical questions, and the like. For instance, gathering patient information, obtaining patient medical history, asking contextual questions regarding the reason for the visit, or the like may be completed by a user prior to the arrival of a user at a medical care provider facility. As such, the number of administrative tasks performed upon arrival of the user may be minimized and other attendant benefits may be provided as will be discussed in greater detail below.

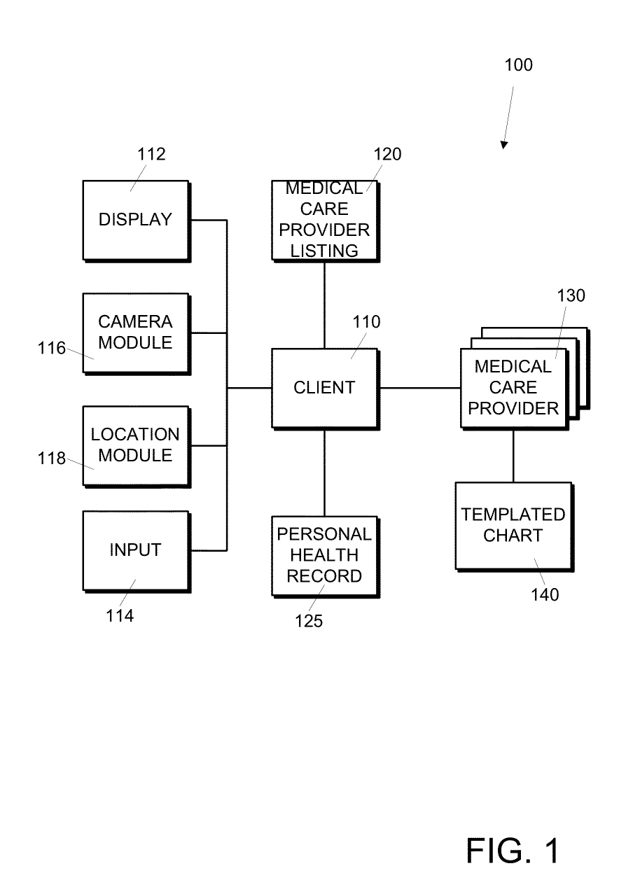

With reference to FIG. 1, an embodiment of a system 100 for communicating information from a client 110 to one or more medical care providers 130 is shown. The system 100 may be used to communicate information from the client 110 to the one or more medical care providers 130 prior to the arrival of a user to a medical care provider facility. The client 110 may be located remotely from any medical care provider facility. For instance, the client 110 may comprise a program or application executing on a personal computer or a mobile device. Additionally or alternatively, the client 110 may comprise a web browser executing on a personal computer or mobile device. In one embodiment, the client 110 may be executed on a device that is convenient for the user to access (e.g., a personal computer in the home of the user or a mobile phone of the user).

In this regard, the client 110 may be in operative communication with a display 112 and/or an input 114. The display 112 and input 114 may be operable to provide a graphical user interface. For instance, the display 112 may be any appropriate type of display including, without limitation, an LCD display, CRT monitor, or other appropriate type of display. The display 112 may be associated with, for instance, a mobile device, a laptop computer, a desktop computer, etc. Also, any appropriate type of input device 114 may be provided including, but not limited to, a keyboard, mouse, touch screen device, track ball, or other appropriate input device.

The client 110 may also be operative to interface with modules for performing specific tasks. For instance, these modules may be associated with the device on which the client 110 is executed. For instance, as shown in FIG. 1, the client 110 may be in operative communication with a camera module 116. The camera module 116 may be operative to capture still images or video, which may be provided to one or more medical care providers 130 by the client 110 as will be discussed in greater detail below. The camera module 116 may include hardware, firmware, software, or any combination thereof operable to obtain still images or video.

Additionally, the client 110 may be in operative communication with a location module 118. The location module 118 may be operable to determine location information without receiving input from the user. In this regard, location information may be obtained and provided to the client 110 even in situations where the user is unaware of his or her current location. Different network-based or device-based technologies may be used by the location module 118 to resolve location information. For instance, an IP address or other characteristic of the device executing the client 110 may be analyzed to determine location information of the device. Alternatively, the location module 118 may comprise a GPS module or other location aware module. Such location aware modules may use various techniques such as angle of arrival, time difference of arrival, strength of signal, or other appropriate techniques for determining the location of a device.

In one particular embodiment, the client 110 may execute on a mobile device. In this regard, the camera module 116 and location module 118 may be integrated modules of the mobile device. That is, the camera module 116 may be integrated with the mobile device and may be used to capture still images or video that are provided to the client 110. Furthermore, a location module 118 may be integrated with the mobile device (e.g., in the form of a GPS chipset or other module operative to locate the mobile device).

In any regard, the client 110 may be operable to access a medical care provider listing 120. The medical care provider listing 120 may contain information (e.g., entries) regarding the plurality of medical care providers 130. The medical care provider listing 120 may be stored in a database that is accessible by the client 110. In the depicted embodiment of FIG. 1, the medical care provider listing 120 may reside locally (e.g., in local memory of a device executing the client 110). The medical care provider listing 120 may include medical care provider entries for each respective medical care provider 130. These entries may include, but are not limited to, information regarding each medical care provider's location, specialty, types of insurance accepted, medical network affiliations, languages spoken, experience, or other appropriate information.

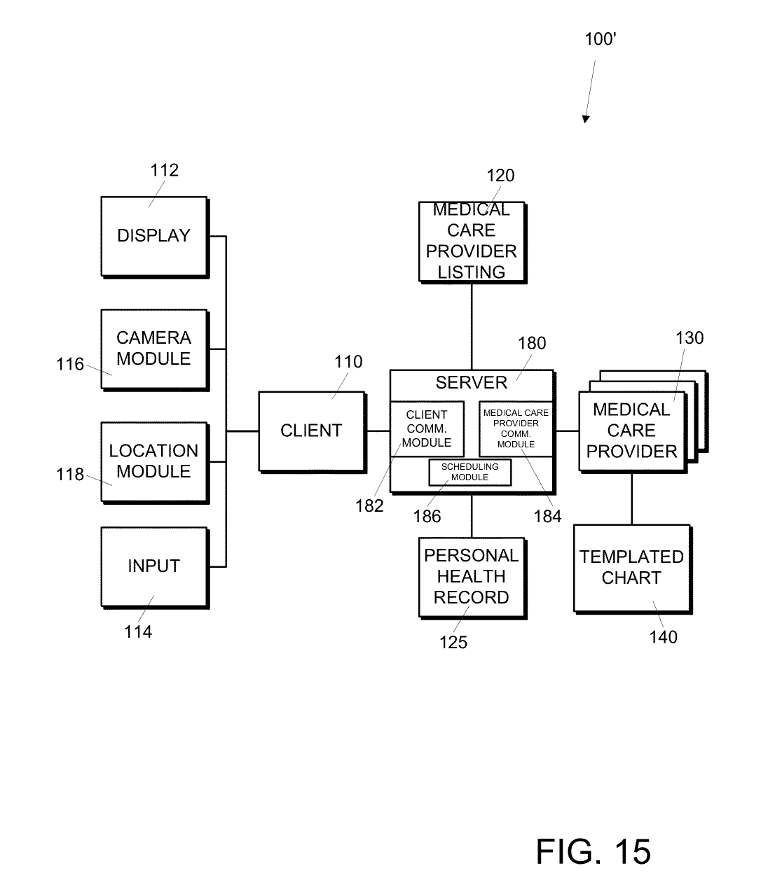

With additional reference to FIG. 15, another embodiment of a system 100′ is depicted wherein the client 110 is in operative communication with a server 180. In this regard, the server 180 may be remote from the client 110. The server 180 may have stored thereon or be operative to access the medical care provider listing 120 for communication to the client 110. As such, a client communication module 182 may be provided at the server 180 for receipt of data from the client 110 and transmission of data to the client 110.

In any regard, the medical care provider listing 120 may be searched to narrow or filter the medical care provider entries presented to a user. In various embodiments, the medical care provider listing 120 may be searched based on any of the information included in the medical care provider entries, without limitation. For instance, in one embodiment, location information (e.g., manually entered by a user or obtained via the location module 118) may be used to search medical care provider entries contained in the medical care provider listing 120 to identify medical care provider facilities near the location described by the location information. The medical care provider entries may be presented in an ordered manner such that the medical care provider entries are arranged in order of nearest to furthest from the location of the user. The searching of the medical care provider listing 120 may be performed locally by the client 110. Alternatively, such searching may be performed by the server 180 and communicated to the client 110 by way of the client communication module 182.

Alternatively or additionally, the medical care provider listing 120 may be searched or filtered by medical network information. Medical network information may include, but is not limited to, an insurance carrier, an HMO, or other type of medical network. Such medical network information may be provided manually by the user or may be included in a personal health record 125 for the user. For instance, a user may provide information regarding the user's medical insurance carrier either manually or by accessing his or her personal health record 125. This information may be used to search or filter the medical care provider listing 120 such that only providers accepting insurance from the insurance carrier provided are shown.

Accordingly, the client 110 may be operable to access a user's personal health record 125. The personal health record 125 may include information regarding the user. This information may include personal information (e.g., age, sex, address, race/ethnicity, contact information, etc.), medical history information (e.g., past illnesses, procedures, blood type, allergies, medications currently or previously taken medications, immunizations, etc.), medical network information (e.g., insurance carrier(s), HMO affiliation(s), etc.), or other appropriate information regarding the user. The user's personal health record 125 may be stored in a memory at the device executing the client 110 (i.e., locally) or may be stored remotely from the client 110. In this latter instance, the client 110 may be operable to access the personal health record 125 of the user to retrieve the information contained therein. For instance, the personal health record 125 may be stored remotely at a server (e.g., server 180 or a separate server in communication with server 180 as shown in FIG. 15). Access to the personal health record 125 may be secured (e.g., by way of encryption technology, through use of a username/password combination, another appropriate security technology, or any combination thereof).

The client 110 may also be in operative communication with a plurality of medical care providers 130. Information may be passed from the client 110 to any or all of the medical care providers 130 with which the client 110 is in communication. In this regard, a user may employ the client 110 to facilitate communication of information to a medical care provider 130. As the client 110 is potentially located remotely from the medical care providers 130, this communication of information from the client 110 to a medical care provider 130 may be performed prior to the arrival of a user to a medical care provider facility (e.g., using a home computer, mobile device, or the like). The communication of information from the client 110 to the medical care provider 130 may provide advantages over prior systems of collecting user information. Alternatively, as shown in FIG. 15, the client 110 may communicate with the server 180 by way of the client communication module 182. In turn, information may be relayed by the server 180 to the plurality of medical care providers 130 by way of a medical care provider communication module 184. That is, the client 110 may pass information to the medical care providers 130 by way of the server 180.

The client 110 may be used to make appointments with medical care providers 130. The medical care providers 130 may communicate real time date to the client 110, which may include available appointment times. The client 110 may be operative to display the currently available appointment times for any or all of the medical care providers 130. The user may select an appointment time using the client 110. Such communication may be facilitated using any one of or a combination of means of communication. For example, the client 110 may directly interface with a practice management system of any or all of the respective medical care providers 130 to allow a user of the client 110 to make appointments using the client 110. Alternatively, other communications (e.g., automatically generated e-mails, automated telephone calls, etc.) may be used to reserve available appointments using the client 110. Further still, intermediaries may be employed between the client 110 and medical care providers 130 to facilitate communication of such information between the client 110 and the one or more medical care providers 130 such as the scheduling module 186 shown in FIG. 15. The scheduling module 186 may reside on the server 180 and facilitates communication between the client 110 and medical care providers 130 to manage appointment scheduling in any of the foregoing respects.

In at least some embodiments, the client 110 may be operative to communicate an indication to a medical care provider 130 that a user of the client 110 intends to visit the medical care provider 110. This may or may not be in connection with an appointment that is reserved in a manner described above. For instance, in the context of an emergency room, an indication may be provided to an emergency room of an intent of a user to visit the emergency room without making an appointment corresponding to the visit. In connection with the indication of an intent to visit a medical care provider facility, information may be passed from the client 110 to the medical care provider 130 prior to the visit. For instance, user information may be sent to the medical provider, including such information as the user's name, social security number, contact information, etc. Also, the user's medical history may be transmitted from the client 110 to the medical care facility 130. In one embodiment, this information is accessed from the user's personal health record 125 in a manner described above. Additionally or alternatively, the user may manually enter some or all of the information using the client 110.

In addition, information regarding the reason for the current visit to the medical care provider 130 may be transmitted to the medical care provider 130. This may include information related to a suspected disease or condition, information related to a needed medical procedure, or the information may relate to symptoms the user is experiencing. In any regard, such an indication of a disease, medical condition, needed medical procedure, or symptom may be selected from one or more lists presented by the client 110 or may be entered in free form by the user.

As part of this information regarding the reason for the current visit, information collected via the camera module 116 may also be provided to assist in describing or illustrating a medical condition, a disease, or a symptom. For example, the user may currently be suffering from a rash. The user may photograph the rash using the camera module 116 and include the photograph(s) along with the information provided to the medical care provider 130. Such photograph(s) may be used to assist the medical care provider 130 in diagnosing or treating the condition and may be entered into the user's personal health record 125 as will be discussed in greater detail below.

Additionally, special requests may be transmitted to the medical care facility 130 prior to arrival. For example, a request may be made (e.g., for a curbside wheel chair or other assistance) such that medical care provider personnel may be ready to assist the user upon arrival. As a further example, the user of the client 110 may not be the patient seeking treatment, but rather a third party (e.g., an emergency medical technician (EMT) or the like). In this regard, the third party may use the client 110 to notify a medical care facility 130 of the expected arrival of a patient prior to the arrival of the patient to which the third party is providing care. As such, the information communicated to the medical care provider 130 may include the nature of the injury or illness, steps taken by the third party prior to arrival at the facility, special requests for resources, or other information pertinent to the situation.

In any regard, information of any kind transmitted to the medical care provider 130 prior to the arrival of a user or patient may be utilized by the medical care provider 130 to create a templated chart 140. The templated chart 140 may be used when providing medical care to the user or patient upon arrival to the medical care facility 130. For instance, the templated chart 140 may include the user data, medical data, or other information provided by the user and may eliminate or reduce the need to manually collect such data from a user or patient upon arrival at the medical care facility 130. In this regard, upon transmission of information from the client 110 to the medical care provider, the template chart 140 may be generated automatically.

The templated chart 140 may be used to further reduce the administrative overhead associated with medical care provider visits by requesting contextual information from the user of the client 110. For example, upon requesting an appointment or notifying the medical care facility 130 of an intent to visit, the client 110 may present contextual questions to the user regarding the nature of the visit. These contextual questions may be based upon, for example, an indication of a symptom, a condition, a disease, or a procedure. The contextual questions may comprise questions that are normally asked by medical care provider personnel upon arrival to the facility.

For instance, a user may indicate, using the client 110, an intent to visit a medical care provider 130 due to flu-like symptoms. In the context of an indication to a medical care provider 130 of an intent to visit the medical care provider 130 for treatment of flu-like symptoms, a number of contextual questions may be presented to the user. These contextual questions may include requests for details regarding the symptoms (e.g., when the symptoms first occurred, the severity of the symptoms, etc.), requests for details regarding the user's behavior (e.g., recent contact with ill persons, recent travel, etc.), or other appropriate requests for information. The contextual questions may be tailored to a specific medical care provider, symptom, disease, procedures, etc. For example, the contextual questions presented via the client 110 may be different if the indicated reason for the visit is a broken bone rather than flu-like symptoms.

Additionally, the information provided to the medical care provider 130 may allow for resources at the medical care facility 130 to be reserved. The reservation of resources contemplates reserving personnel resources (e.g., doctors, nurses, physician's assistants, etc.), equipment, examination rooms, or other resources of the medical care provider facility. The reservation of resources may also be dependent on the indicated reason for the visit. For example, the resources reserved for an indication of a broken bone may be different than the resources reserved for an indication of flu-like symptoms.

In one embodiment, the medical care providers 130 may also be operative to provide real time information to the client 110. This may be used to create or supplement the medical care provider entries in the medical care provider listing 120. For instance, each of the medical care providers 130 may be capable of accessing a corresponding medical care provider entry in the medical care provider listing 120 to update or change information provided regarding the medical care provider 130.

Additionally, any or all of the medical care providers 130 may provide information to the client 110 that reflects the current status of each of the providers 130. For instance, current available appointment times, current wait times, or other appropriate information may be communicated to the client 110. Due to the potentially time sensitive nature of such information, the information may be provided in substantially real time. Thus, the client 110 may be operative to use such real time information in searching or filtering the medical care provider listing 120 (e.g., to sort medical care providers from least to greatest current wait times or to show medical care providers with current available appointments). As indicated above, this real time information may be manually entered by the medical care providers 130 or the client 110 may directly interface with practice management systems of the medical care providers 130 to retrieve or generate such real time information.

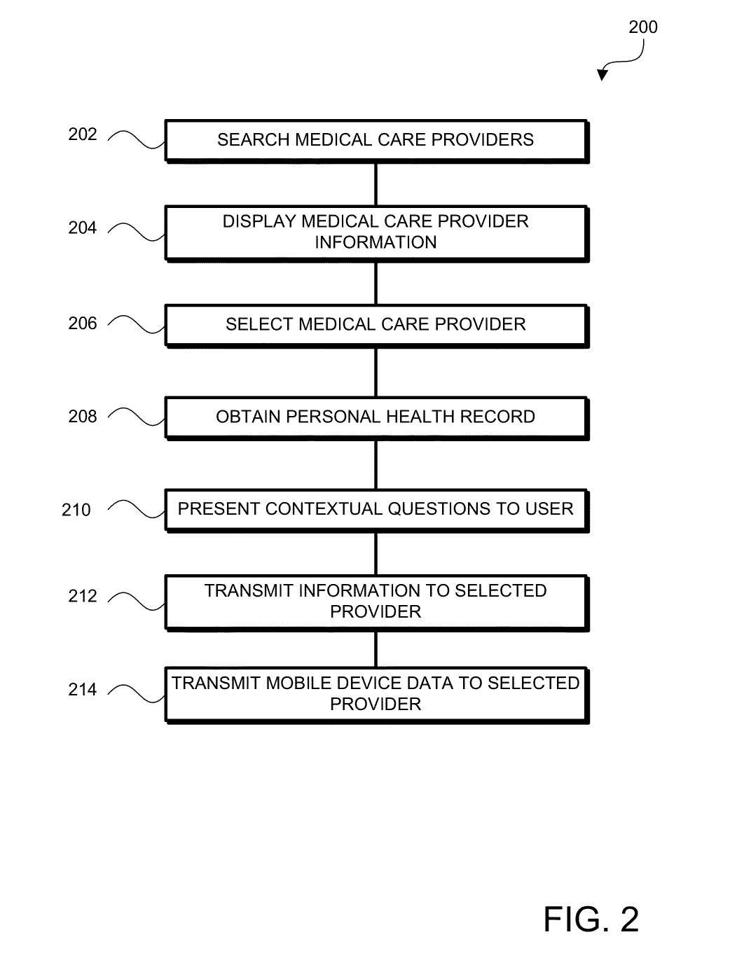

One embodiment of a method 200 for communicating information between a client and a medical care facility is shown in FIG. 2. The method 200 may include searching 202 a listing of medical care providers. The searching 202 may include structured searches which allow for filtering or narrowing of a listing of medical care providers based on attributes provided in the medical care provider listing. The method 200 may further include displaying 204 medical care provider information. This may include displaying 204 the results returned from the searching 202. The method 200 may additionally include selecting 206 a medical care provider. The selecting 206 may result in the display of additional information regarding the selected medical care provider and/or may indicate an intent to visit the selected medical care provider.

The method 200 further includes obtaining 208 a personal health record. As described above, when obtaining 208 a personal health record, a user may manually enter the information or may access data which is stored remotely or locally with respect to the client. The method 200 may further include presenting 210 contextual questions to the user. The contextual questions, as discussed above, may be based upon an indication of a symptom, a disease, a medical procedure, or other information provided by the user. The indication of a symptom, a disease, a medical procedure, or of the information may, in at least some embodiments, correspond to a reason for the visit to the medical care provider. The method 200 may further include transmitting 212 information to the selected medical care provider. This information may encompass information obtained via accessing or receiving the personal health record of the user and/or the responses to the contextual questions presented 210 to the user.

Additionally, the method 200 may include transmitting 214 mobile device data to the selected medical care provider. In an embodiment where the client is executing on a mobile device, the mobile device data may include location data, still image data, or video data obtained via the location module 118 or camera module 116 of the mobile device. In this regard, mobile device data may include data generated by the mobile device without receiving the data from a user. In any regard, the transmission 212 of information and/or transmission 214 of mobile device data may include any appropriate means of communicating such information to the selected medical care facility. Examples include, but are not limited to, direct transmission of the data to a practice management system, by SMS/MMS messaging, by e-mailing, by faxing, by telephoning, by way of a server, or any combination thereof.

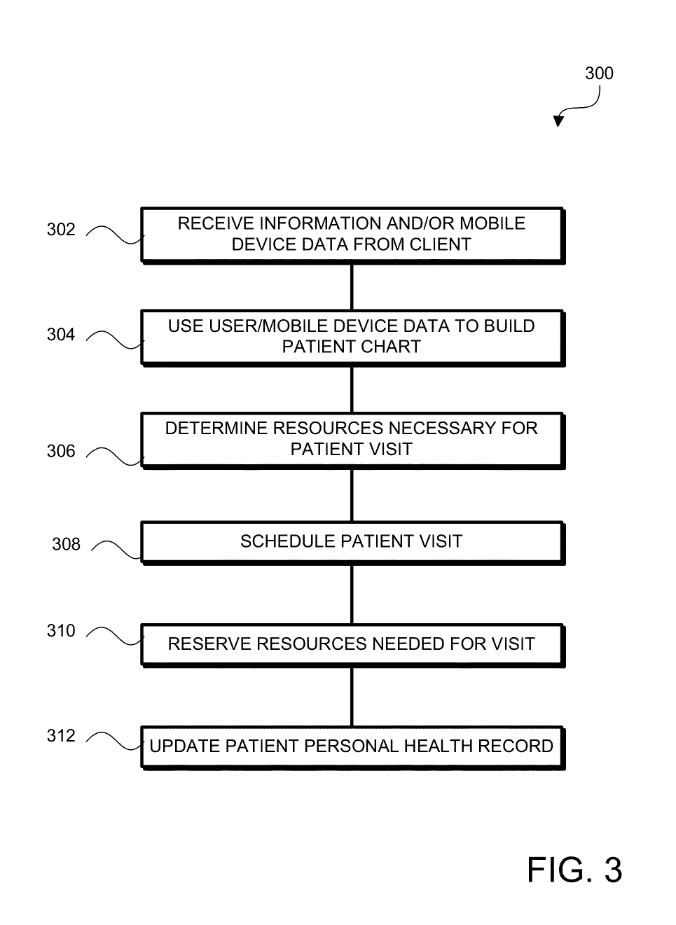

FIG. 3 depicts a method 300 which may be performed by a medical care provider. The method 300 may include receiving 302 information and/or mobile device data from a client. The information and/or mobile device data may be received directly by a practice management system of the medical care provider, a receptionist, or any other personnel of the medical care provider. The medical care provider may then use 304 the information received to build a patient chart. For example, user information, past medical history, and details regarding the current reason for the user's visit may be used 304 to build or supplement a user's chart at the medical care facility.

The method 300 may also include determining 306 what resources are necessary for the visit. For example, based on an indicated symptom, disease, or medical procedure, the appropriate resources (e.g., including personnel, equipment, etc.) may be identified. In this regard, the method 300 may also include scheduling 308 the patient and reserving 310 the necessary resources for the patient visit. Additionally, after the patient visit, the medical care provider may update 312 the patient's personal health record. Thus, the care administered may become part of the user's personal health record 125 (e.g., which may subsequently be provided to another medical care provider at a different instance).

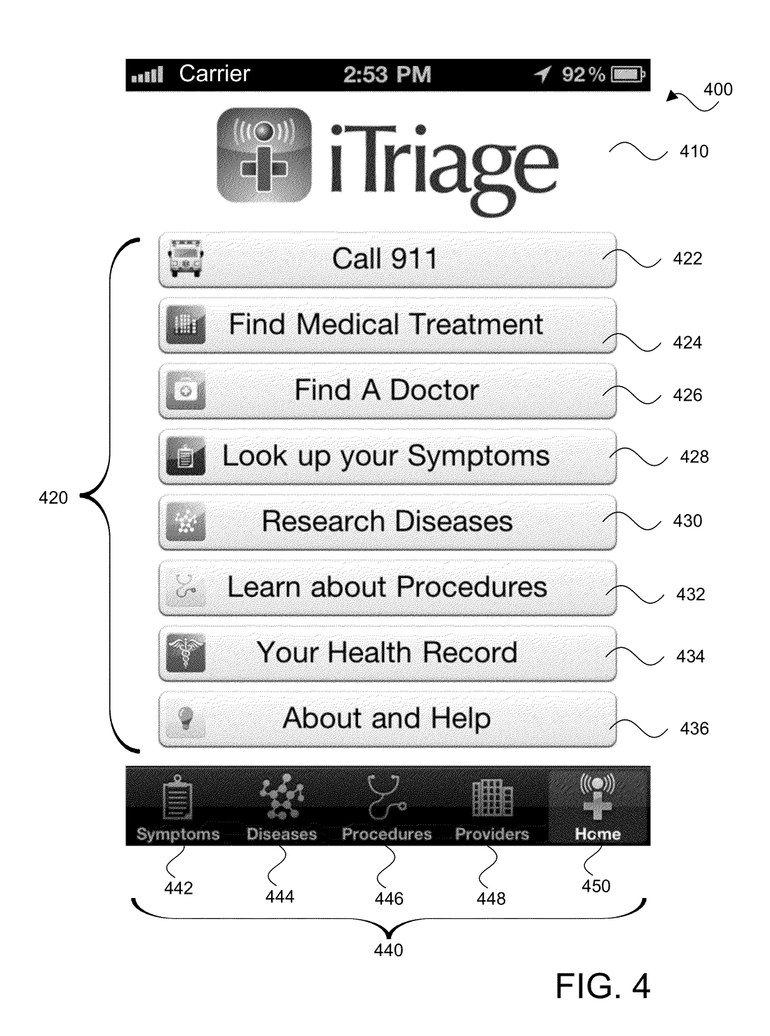

As stated above, the client 110 may be executed as an application on a mobile device. Screen shots of one such embodiment of a client 400 are shown in FIGS. 4-14. The specific implementation depicted, including the functionality and layout thereof, is shown by way of example only and is not intended to limit the present invention to the particular embodiment shown. Thus, other clients with alternative functionality and layouts may be provided in accord with discussion presented above.

FIG. 4 shows a home screen 410 which may be displayed upon start-up of the client 400. The home screen 410 may have a number of buttons 420 which a user may use to navigate within the client 400. Also, a number of quick links 440 may be provided along the bottom of the screen of the client 400 regardless of the screen displayed by the client 400. In this regard, the quick links 440 may be used to navigate to corresponding screens regardless of the screen displayed by the client 400.

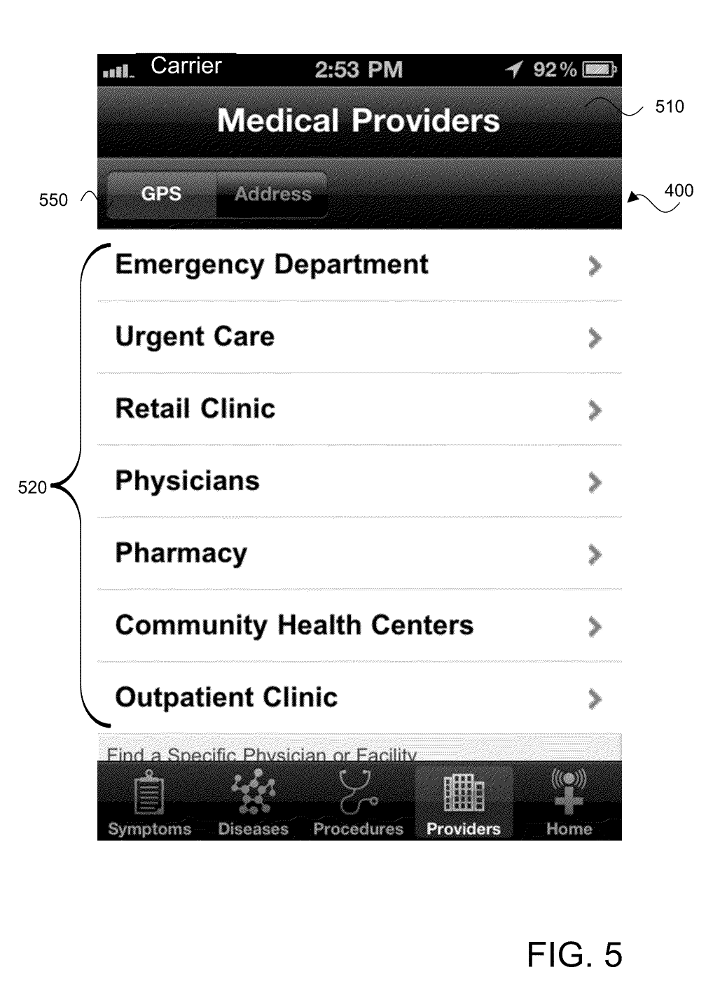

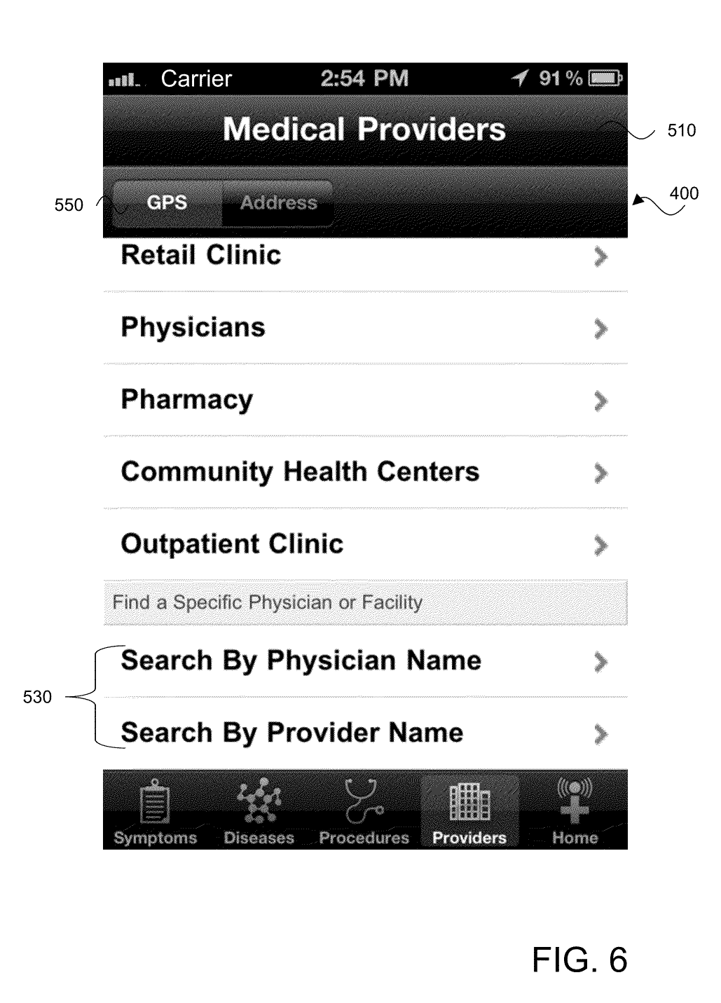

The buttons 420 may include an emergency button 422. In the case of an emergency, the emergency button 422 may be selected to contact emergency personnel. This may result in the client 400 accessing the telephony capability of the mobile device on which it is executing (e.g., to dial 911). Additionally, the buttons 420 may include one or more providers buttons 424, 426 for navigating to a medical providers search screen for searching a listing of medical care providers. Also, a providers quick link 448 may be provided for navigating to a medical providers search screen to search a listing of medical care providers. A medical providers search screen 510 for searching medical care providers is shown in FIGS. 5 and 6 and will be discussed in greater detail below. Also, a symptoms button 428 may be provided for navigation to a symptoms listing screen. Also, a symptoms quick link 442 may also be provided to navigate to the symptoms listing screen. From the symptoms listing screen, a user may browse or search a listing of symptoms. For example, associated causes of the symptoms, photos, videos, courses of treatments, medical care providers capable of addressing the causes of the symptoms, or other appropriate information related to the symptom may be provided.

There may also be a diseases button 430 for navigating to a disease listing screen. Also, a diseases quick link 444 may be provided that allows a user to navigate to a disease listing screen. The disease listing may provide a list of disease to the user. A selection of a disease from the disease listing may present further options or information that may include links to descriptions of the disease including symptoms associated with the disease, tests used to diagnose the disease, courses of treatment for the disease, videos, images, or other information related to the disease. Additionally, there may be a procedures button 432 which navigates to a medical procedure listing. Also, a procedures quick link 446 may be provided that also navigates to the medical procedure listing. From the medical procedure listing, a user may select a medical procedure. Subsequent screens may be presented that allows a user to research a selected procedure. For example, links to information regarding the procedure may be provided including a description of the procedure, medical providers capable of performing the procedure, possible complications, average costs, images, videos, or other information related to a selected medical procedure.

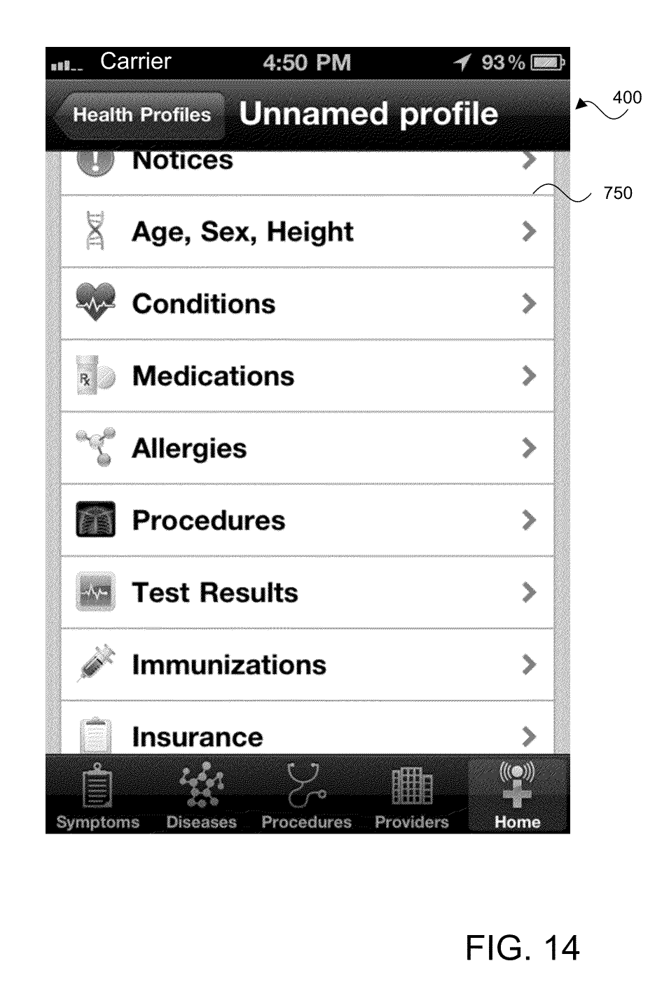

The home screen 410 may also have a personal health record button 434 that navigates to a personal health records screen 750, which is shown in FIG. 14 and will be discussed in greater detail below. Furthermore, help button 436 may be provided that provides additional details regarding the client 400 and may provide support for use of the client 400. Also, a home quick link 450 may be provided for accessing the home screen 410 regardless of the screen displayed by the client 400.

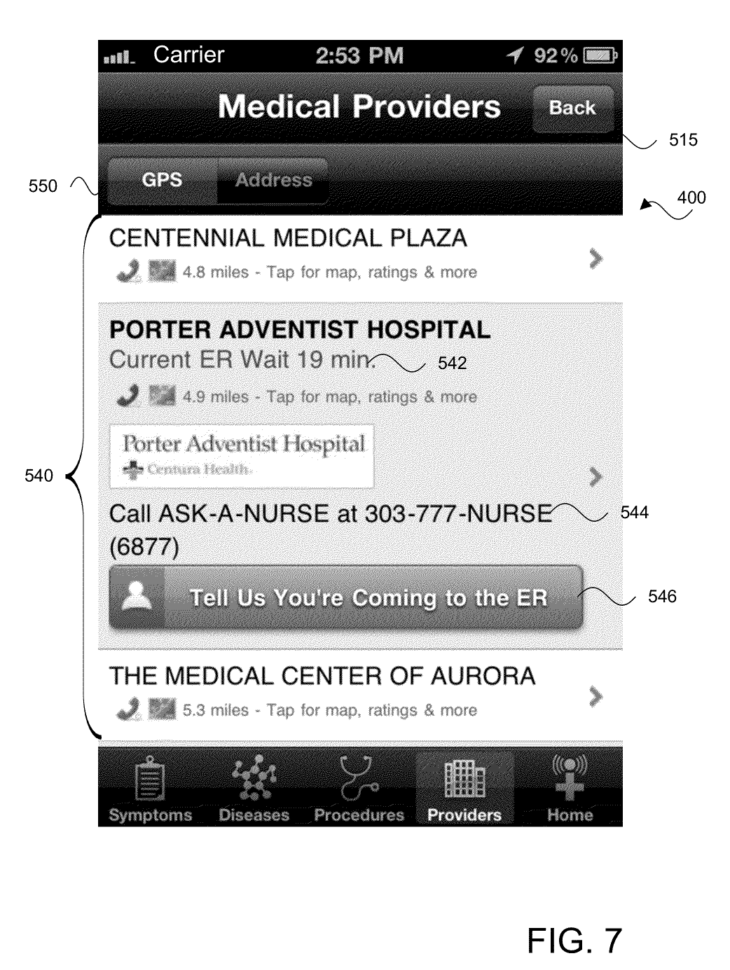

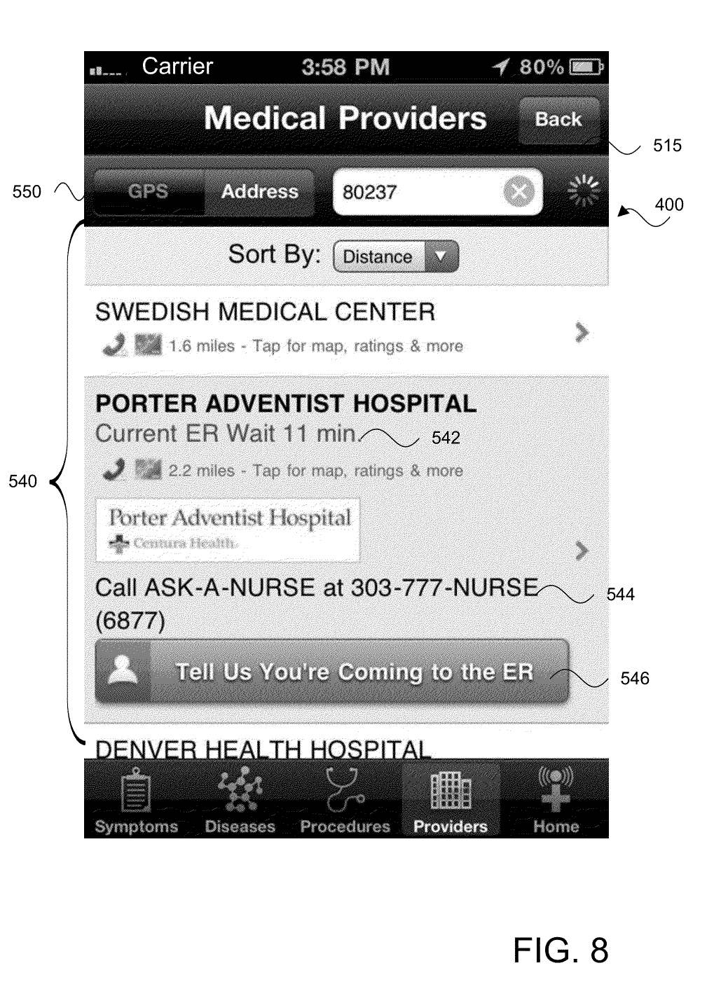

With further reference to FIG. 5, a medical providers search screen 510 is shown. The medical providers search screen 510 may be accessed by way of providers button 424, providers button 426, or providers quick link 448. As shown, a number of medical provider categories 520 may be listed on the medical providers search screen 510. These medical provider categories 520 may correspond to different types of medical care providers and provide a user the ability to search based on the category of provider. Alternatively, as shown in FIG. 6, options for searching by physician name or by provider name may be provided as links 530. Additionally shown in FIGS. 5 and 6 is a location module control 550. As will be discussed in greater detail below, the location module control 550 may allow for a user to obtain a location of the mobile device executing the client 440 by way of a GPS module or may allow for manual input of location information to assist in searching the medical care provider listing. Once a category 520 of medical provider has been selected, a listing 540 of providers (e.g., listed in order of near to far based on location information) may be presented in a medical providers screen 515 as shown in FIGS. 7 and 8.

With additional reference to FIGS. 7 and 8, the listing 540 of medical care providers may be sorted from nearest to furthest based on location information. As shown in FIG. 7, the “GPS” option on the location module control 550 is selected. As such, an integrated GPS module of the mobile device may acquire location information which the client 400 uses to determine the nearest medical care providers for display in the listing 540. Alternatively, as shown in FIG. 8, the “Address” button on the location module control 550 may be selected such that a free form text box is displayed on the location control module control 550. As such, location information (e.g., an address, zip code, city and state, etc.) may be manually entered by the user to search for medical care providers near the entered location information.

With further reference to FIGS. 7 and 8, any of the medical care providers appearing in the listing 540 may be selected in order to access more information regarding the medical provider. At least some of the medical providers may have entries in the listing 540 that include real time information 542. For instance, a medical care provider entry may include real time information 542 including the current wait time at an emergency room. Also, contact information 544, such as telephone numbers, email addresses, etc. may be provided. Additionally, a notification button 546 may be provided. By selecting the notification button 546, the corresponding medical care provider may be notified of an intent of the user to visit the facility.

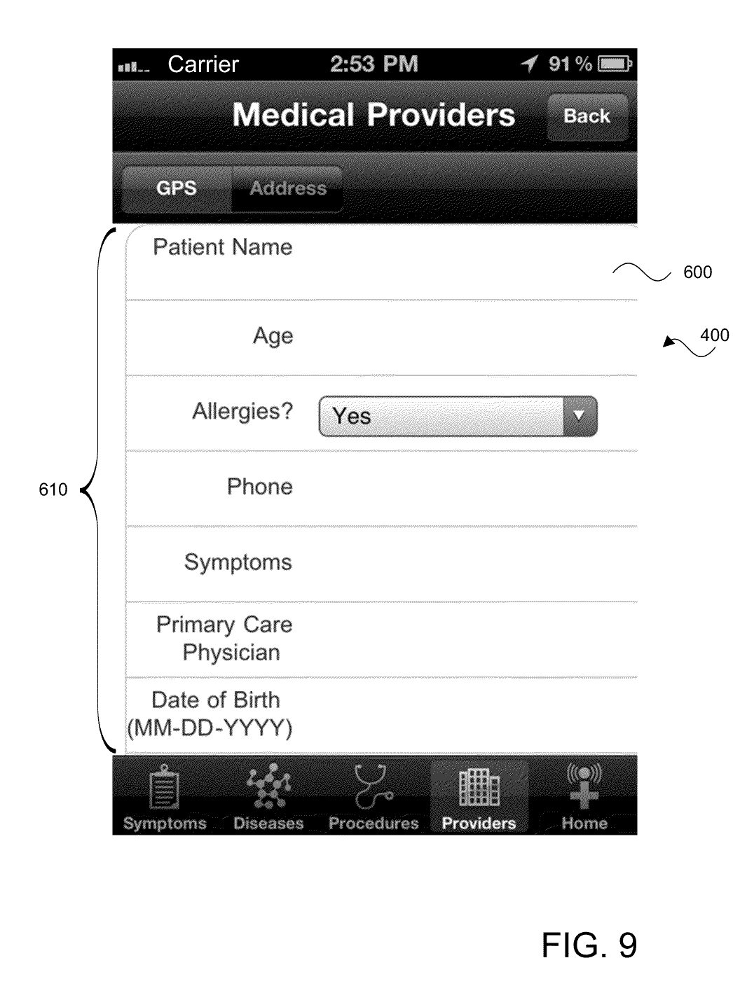

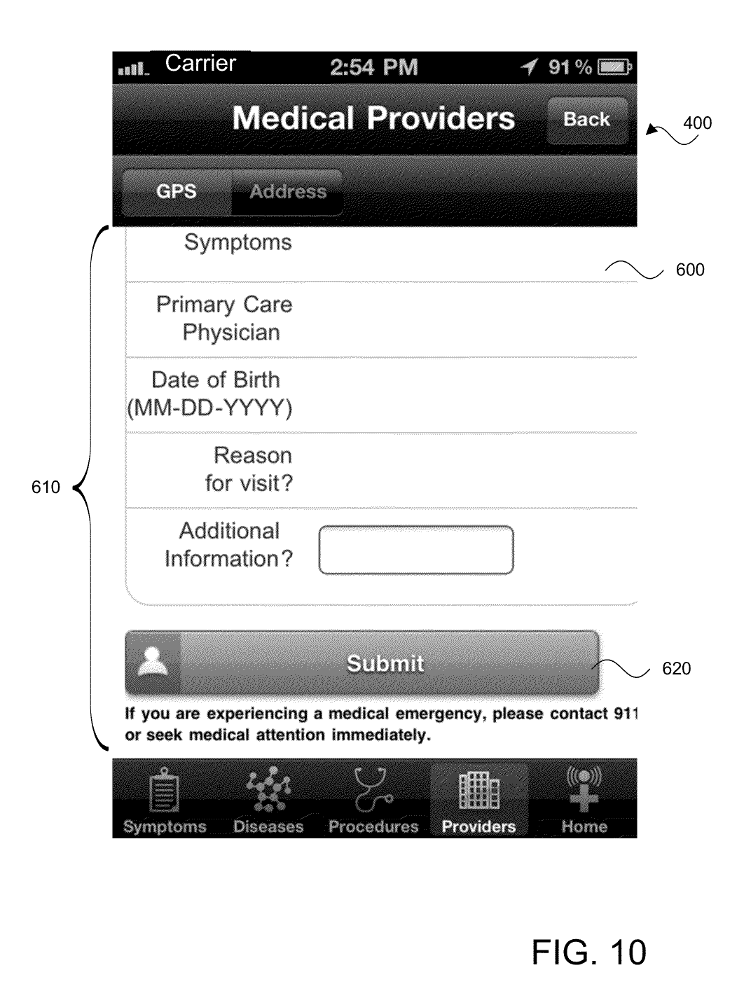

Once the notification button 546 has been selected by the user, an information input screen 600 including one or more data prompts 610 may be displayed to the user, as shown in FIGS. 9 and 10. The data prompts 610 may include text entry boxes for entry of the patient's name, age, allergies, contact phone number, symptoms, primary care physician, the date of birth, current reason for the visit, and a field where any additional information may be entered. While not shown, the data prompts 610 may also include contextual questions described above (e.g., based at least partially on an input received at one of the data prompts 610). A submit button 620 may be selected when the data prompts 610 have been completed to transmit the data to the selected medical care facility.

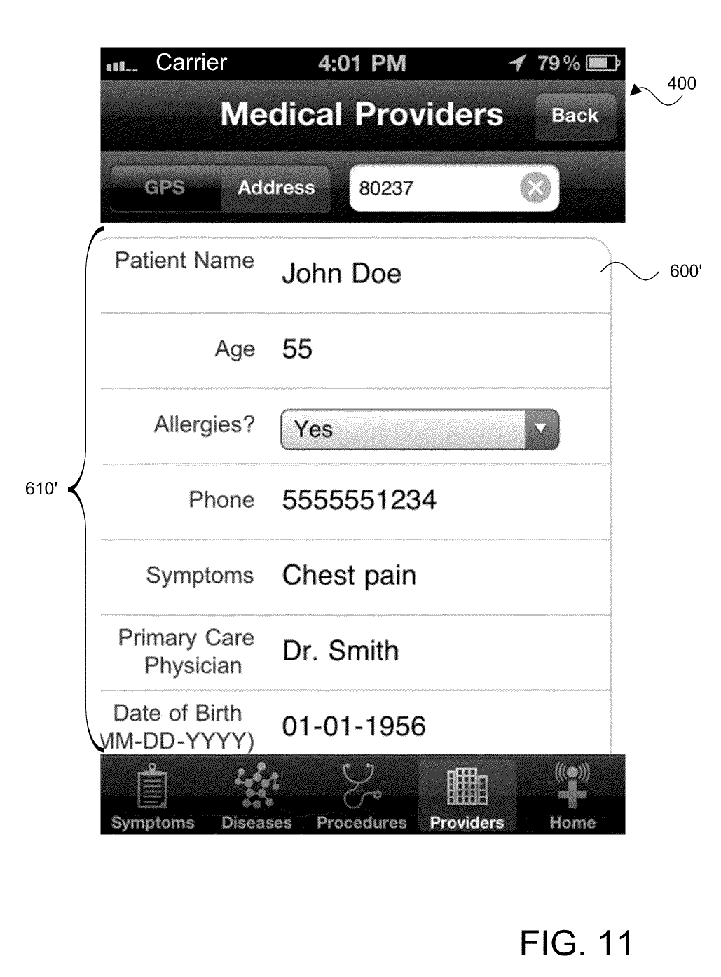

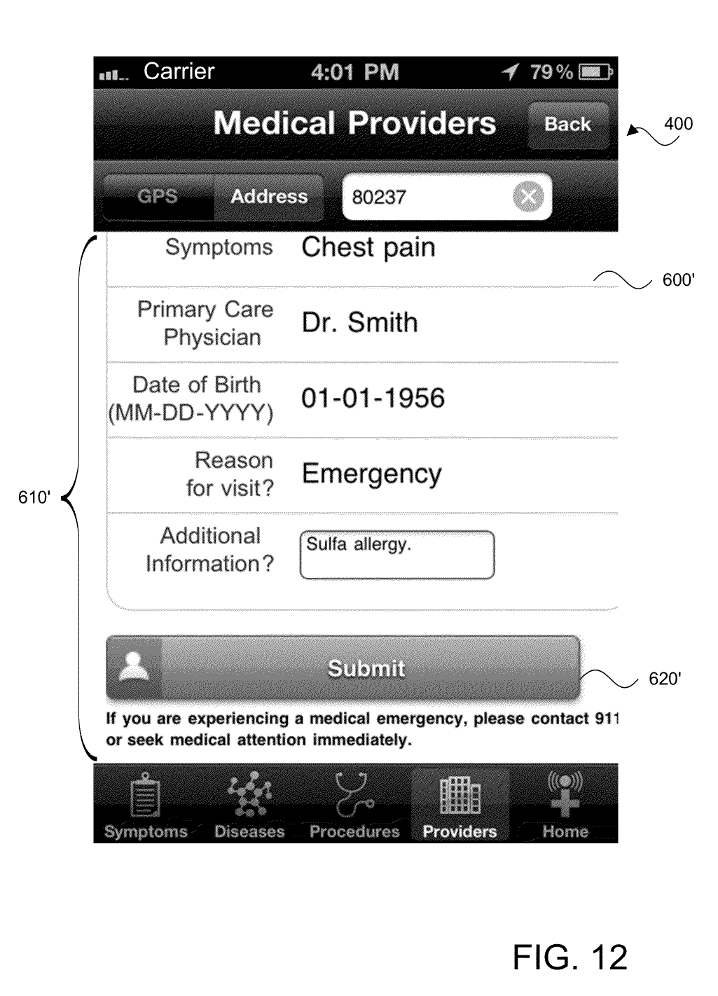

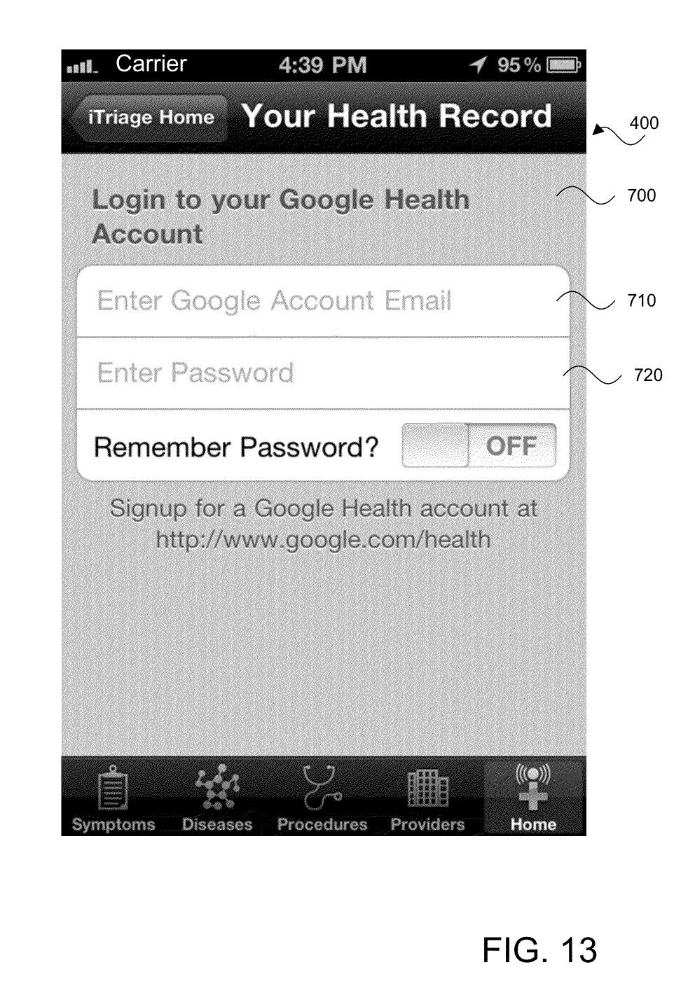

An example of completed data prompts 610′ on an information input screen 600′ is shown in FIGS. 11 and 12. Alternatively, information may be accessed by the client 400 for transmission to a selected medical care facility by way of access to a personal health record. FIG. 13 shows one such way of accessing a personal health record. A login screen 700 may include a username field 710 and a password field 720. By entering an appropriate username and password combination, a user may log into his or her personal health profile. One such health profile screen 750 is shown in FIG. 14. From the health profile screen 750, a user may enter information related to his or her age, sex, height, medical conditions, current or past medications, allergies, procedures, test results, immunizations, insurance information, or other information pertinent to his or her health record. As such, when providing information to a medical care provider, a user may log into his or her personal health record to transmit the data contained therein to a selected medical care provider. This may be done in conjunction with or as an alternative to providing information in the data prompts 610 shown in FIGS. 9 and 10.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences, with additional steps, or with fewer steps than shown). Accordingly, it should be understood that only some embodiment and variants thereof have been shown and described and that all changes and modifications that come within the spirit of the invention are desired to be protected.

1. A method for use in communicating information pertaining to medical care using a computer-based application executing on a computing device, the method comprising:
receiving, at a user interface of the computing device, a selection of a selected medical care provider selected from a medical care provider listing displayed on said user interface and comprising information related to a plurality of medical care providers, wherein said selection indicates a patient intends to visit said selected medical care provider;
obtaining, at said computing device, patient data regarding said patient;
receiving contextual information from one or more data prompts provided to a user via said user interface of said computing device, said one or more data prompts including at least one contextual question, wherein said contextual question is at least partially in response to an indication of at least one of a symptom, a disease, or a medical procedure provided by said user using said user interface of the computer-based application;
automatically generating a templated chart that is at least partially based on said patient data and said contextual information for use in providing medical care to said patient at said selected medical care provider; and
automatically transmitting, from said computing device using a microprocessor of the computing device, said templated chart to said selected medical care provider prior to said patient visiting said medical care provider.

2. A method according to claim 1, further comprising:
searching said medical care provider listing based on a location of said patient.

3. A method according to claim 2, wherein said location of said patient is determined using a location module of a mobile device.

4. A method according to claim 2, further comprising:
filtering said medical facility listing based on medical network information.

5. A method according to claim 1, wherein said patient data at least partially comprises a personal health record.

6. A method according to claim 5, wherein said personal health record is retrieved by way of access to a server.

7. A method according to claim 6, wherein said access to said personal health record is secure and requires a name and password combination.

8. A method according to claim 1, wherein said templated chart is employed by said medical facility to reserve resources at said selected medical care provider.

9. A method according to claim 1, further comprising:
providing available appointment times for said selected medical care provider;
receiving a selection of a selected appointment time; and
sending an indication of said selected appointment time to said selected medical care provider.

10. A method according to claim 1, wherein said at least one of a symptom, a disease, or a medical procedure provided by said user is provided during said obtaining.

11. A method according to claim 10, wherein said at least one of a symptom, a disease, or a medical procedure provided by said user corresponds to an indicated reason for said visit to said selected medical care provider.

12. A method for use in communicating information pertaining to medical care provider using a mobile device, comprising:
presenting to a user, on a user interface of said mobile device, one or more patient data prompts;
collecting patient data from said one or more patient data prompts of said user interface of said mobile device, wherein said patient data comprises at least one of identification information, medical information, or medical network information related to a patient;
generating mobile device data using said mobile device, wherein said mobile device data is not collected using said one or more data prompts, said mobile device data comprising at least one of location information of said mobile device, audio, a picture, or video;
transmitting said patient data and said mobile device data from said mobile device for delivery to a medical care provider;
wherein said transmitting occurs prior to administration of said medical care to said patient, and wherein at least a portion of a chart for providing medical care to said patient at said medical care provider is automatically generated based on said patient data and said mobile device data.

13. A method according to claim 12, wherein said user is said patient.

14. A method according to claim 12, further comprising:
searching a medical care provider listing using said mobile device;
presenting medical care provider information corresponding to results of said searching to said user on said mobile device;
receiving an indication of a selected medical care provider selected from said medical care provider listing.

15. A method according to claim 14, wherein said searching is at least partially based on selection of a symptom, a condition, a disease, a medical procedure, a medical specialty, a wait time, location information, or said medical network information.

16. A method according to claim 15, further comprising:
displaying, on said mobile device, one or more available appointment times for said selected medical provider; and
obtaining a selected appointment time selected from said available appointment times.

17. A method according to claim 16, further comprising:
communicating said selected appointment time for delivery to said selected medical provider.

18-20. (canceled)

21. A method according to claim 12, wherein said one or more data prompts is based at least partially on said selected medical provider.

22. A method according to claim 21, wherein said one or more data prompts includes one or more contextual questions, wherein said one or more contextual questions are at least partially based on at least one of a symptom, a disease, or a medical procedure.

23. A method according to claim 22, wherein user responses to said one or more contextual questions are compiled with said chart for said patient.

24. A method according to claim 23, wherein at least one of said identification information or said medical information is obtained by way of accessing a personal health record corresponding to said patient.

25. A computer executed system executed on a mobile device for communicating medical information, comprising:
a client executed by a processor of the computer executed system that is operative to filter a medical provider listing based on location information determined automatically without input by the user using a location module of the mobile device on which said client is executed and at least one of symptom information, disease information, medical procedure information, appointment availability, a wait time, or medical network information, said medical care provider listing including entries related to a plurality of medical care providers, and said client being disposed remotely from said plurality medical providers that are operable to receive medical information collected at said client; and
a data entry prompt displayable on a user interface of said mobile device by said client to collect said medical information, said data entry prompt being at least partially based on at least one of said symptom information, said disease information, or said medical procedure information, and wherein said data entry prompt comprises at least one contextual question that is in response to at least one of said symptom information, said disease information, or said medical procedure information provided by said user;
wherein said client is operable to transmit said medical information to a server in operative communication with said client, said server being in further operative communication with at least one of said plurality of medical care providers such that said at least one medical care provider receives said medical information for use in providing medical care to a patient prior to said user arriving at said at least one medical care provider.

26. A system according to claim 25, wherein said client is operative to receive a selection of a selected medical care provider selected from said medical care provider listing, wherein receipt of said selection indicates an intent by the user to visit said selected medical care provider.

27. (canceled)

28. A system according to claim 25, wherein said medical information comprises at least a portion of a templated user chart for use at said medical care provider.

29. (canceled)

30. A system according to claim 25, wherein said medical information at least partially comprises a personal healthcare record accessible by said client.

31. A system according to claim 30, wherein said client is operative to communicate with a server to access said personal healthcare record.

32. A system according to claim 31, wherein access to said personal healthcare record is secure, and wherein a username and password combination is required to access said personal healthcare record.

33. A system according to claim 25, further comprising:
an appointment scheduling prompt displayable by said client;
wherein said appointment scheduling prompt is operative to display available appointment times for said selected medical care provider and said appointment scheduling prompt is operative to receive from a user a choice of a selected appointment time from said available appointment times.

34. A computer based system for communicating medical information, comprising:
a client communication module executed by a processor of said computer based system that is in operative communication with a client executed on a mobile device, said client communication module being operable to receive medical information and mobile device data from said client, said medical information comprising an indication of a user's intent to visit at least one of a plurality of medical care providers and said mobile device data comprising at least one of automatically determined location information of said mobile device, audio, a picture, or video;
a chart generation module for automatically generating a templated chart that is at least partially based on said medical information and said mobile device data for use in providing medical care to said patient at said selected medical care provider; and
a medical care provider communication module executed by a processor of said computer based system that is in operative communication with said plurality of medical care providers, said medical care provider communication module being operable to transmit said templated chart to said at least one of said plurality of medical care providers prior to said user visiting said at least one of said plurality of medical care providers;
wherein said medical information at least partially comprises contextual information received from one or more data prompts, said one or more data prompts including at least one contextual question, wherein said contextual question is at least partially in response to an indication of at least one of a symptom, a disease, or a medical procedure provided by a user of said client.

35-36. (canceled)

37. A system according to claim 34, wherein said medical care information at least partially comprises a personal healthcare record.

38. A system according to claim 34, further comprising:
a scheduling module operative to send to said client one or more available appointment times corresponding to one or more of said plurality of medical care providers and receive a selection of a selected appointment time from among said available appointment times.

39. A system according to claim 38, wherein said scheduling module is operative to retrieve from said one or more of said plurality of medical care providers said one or more available appointment times and to send said selected appointment time to a corresponding one of said plurality of medical care providers.

40. A method according to claim 1, wherein said user is said patient.
